(19) United States
(12) Patent Application Publication
(10) Pub. No.: US 2015/0272089 A1
(43) Pub. Date: Oct. 1, 2015

(54) DIFFFUSER, GAS VALVE ADAPTER THEREOF AND METHOD FOR GENERATING MICRO BUBBLES THEREOF

(71) Applicant: QUATEK HOLDING INC., Taipei City (TW)

(72) Inventors: NENG-CHIH Yu, Taipei County (TW); KENG-WEN TSENG, Taipei City (TW)

(21) Appl. No.: 14/666,604

(22) Filed: Mar. 24, 2015

(30) Foreign Application Priority Data
Mar. 28, 2014 (TW) 103111783

(51) Int. Cl. A01K 63/04; B01F 3/04

(52) U.S. Cl. CPC A01K 63/042; B01F 3/04262; B01F 2003/04361

(57) ABSTRACT

A diffuser including a gas supply, gas tank and micro-hole thin-film is provided. The gas tank may be coupled to the gas supply via a gas tube. The micro-hole thin-film has a plurality of micro holes and disposed at the gas outlet of the gas tank. The gas supply can transmit pressurized gas to the gas tank via the gas tube, and the pressurized gas will jet from the micro-hole thin-film to generate a great number of micro bubbles in the water.

### CROSS-REFERENCE TO RELATED APPLICATION

This application claims the benefit of Taiwan Patent Application No. 103111783, filed on Mar. 28, 2014, in the Taiwan Intellectual Property Office the disclosure of which is incorporated herein in its entirety by reference.

### BACKGROUND OF THE INVENTION

1. Field of the Invention

The present invention generally relates to a diffuser, in particular to a diffuser capable of generating a large number of micro bubbles easily solute in water. The present invention further relates to the gas valve adapter thereof and the method for generating micro bubbles thereof.

2. Description of the Related Art

The O₂ content, CO₂ content or other gas content of fish farms, water tanks used in aquaculture or indoor aquariums tend to be insufficient because their volumes are limited; therefore, it is very hard to supply sufficient gas for all animals and plants. Thus, most farmers of the aquaculture use high pressure gas cylinders or other gas supplying devices to inject gas into water via gas diffusers in order to increase the O₂ content or the CO₂ content of water tanks, water pools or aquariums for all animals and plants. For example, when cultivating water weeds or algae, a farmer usually uses a CO₂ diffuser to inject CO₂ into the water of an aquarium to dissolve CO₂ in the water for the plants in the water.

However, the conventional diffusers still have many shortcomings to be overcome. Please refer to FIG 1A and FIG. 1B, which are the schematic views of a conventional diffuser. In general, the conventional diffuser usually uses a high pressure gas cylinder to make gas pass through a porous ceramic, air wood, air stone or other similar materials in order to generate bubbles in the water. For example, the porous ceramic is rough and its holes are generated randomly, as shown in FIG. 1B; therefore, each path inside the porous ceramic 10 is formed by a number of holes randomly connected to each other and is irregular-shaped. If anyone of these holes is blocked, the quantity of the bubbles generated by the diffuser will significantly decrease, or even no bubbles will be generated by the diffuser. Moreover, algae and pollutants in water tend to block or be attached to rough, porous diffusing media with average diameter higher than 10 μm; thus, the porous ceramic tends to be blocked after being used for several day; further, it is very hard to clean the porous ceramic after algae and pollutants in the water block or are attached to the porous ceramic. In general, the porous ceramic will be completely blocked within about one week after being used, so the user should replace it with a new one, which will increase the cost.

Besides, as described above, the porous ceramic 10 is inclined to be blocked by algae and pollutants in the water; thus, the size of the porous ceramic 10 should be increased, which will influence the landscaping of the aquarium and ruin the appearance of the aquarium.

Furthermore, the porous ceramic 10 is inelastic and fragile material with low pressure resistance (about 30 PSI); in general, the porous ceramic 10 will break if the pressure is higher than 25 PSI, which will dramatically increase the production cost of the farmers. Also, as described above, each path inside the porous ceramic 10 is formed by a number of holes randomly connected to each other and is irregular-shaped; and each hole may have different diameter; the diffusing efficiencies of these holes with different diameters are not consistent with each other. Further, as gas is hard to be dissolved in water, it is necessary to increase the gas flow rate of the high pressure gas cylinder to maintain the gas concentration in the water; accordingly, it is not easy to control the gas concentration in the water; therefore, animals and plants in the water may be killed because the gas concentration in the water is too high. Since the diameter of the holes of the porous ceramic 10 is very large, they will also generate big bubbles; as shown in FIG. 1A, as the big bubbles have high buoyancy in the water, they will ascend to the surface of the water in a high speed; thus, the gas in the bubbles will diffuse to the air before being dissolved in the water. Moreover, the total contact area of the big bubbles is lower than that of the small bubbles, so they are very hard to be dissolved in the water, which will influence the performance of the diffuser.

Due to the poor efficiency of the porous ceramic 10, the high pressure gas cylinder should supply more gas; therefore, the farmer should frequently replace it.

Thus, how to provide a diffuser, which can improve the problems that the conventional diffusers tend to be blocked, have poor performance, high cost, short service life, unstable diffusing efficiency and are fragile, has become an important issue.

### SUMMARY OF THE INVENTION

Therefore, it is a primary objective of the present invention to provide a detachable movable device and an electronic device thereof to achieve the effect of reducing the tear and wear of a touch display panel of a general electronic device.

To achieve the foregoing objective, the present invention provides a diffuser, and the diffuser may include a gas supply, a gas tank, a micro-hole thin-film. The gas tank is coupled to the gas supply via a gas tube. The micro-hole thin-film may include a plurality of micro holes and may be disposed at the gas outlet of the gas tank. The gas supply may transmits pressurized gas to the gas tank via the gas tube, and the pressurized gas will jet from the micro-hole thin-film to generate a great number of micro bubbles in the water.

To achieve the foregoing objective, the present invention further provides a method for generating micro bubbles by a diffuser, and the method may include the following steps: providing a gas supply; transmitting pressurized gas to a gas tank via a gas tube; jetting out the pressurized gas from a plurality of micro holes of the micro-hole thin-film of the gas outlet of the gas tank to generate a large number of micro bubbles.

To achieve the foregoing objective, the present invention still further provides a gas valve adapter of a diffuser, and the gas valve adapter may include a gas tank and a micro-hole thin-film. The gas tank is coupled to a gas supply via a gas tube. The micro-hole thin-film may include a plurality of micro holes, wherein the micro-hole thin-film is disposed at the gas outlet of the gas tank. The gas supply transmits pressurized gas to the gas tank via the gas tube, and the pressurized gas will jet from the micro-hole thin-film to generate a great number of micro bubbles in the water.

In a preferred embodiment of the present invention, the diameter of each of the micro holes may be lower than 30 μm.

In a preferred embodiment of the present invention, each of the micro holes may be cone-shaped and may have a narrow top and a wide bottom.

In a preferred embodiment of the present invention, the end of each of micro holes, close to the gas tank, has larger diameter than the other end of each of micro holes.

In a preferred embodiment of the present invention, the micro-hole thin-film may be a plastic film.

In a preferred embodiment of the present invention, the micro-hole thin-film is a metal film.

The diffuser, gas valve adapter and the method for generating micro bubbles thereof according to the present invention have the following advantages:

(1) In one embodiment of the present invention, the diffuser has the micro-hole thin-film, so the diffuser is able to generate a great number of micro bubbles. The micro bubbles are very easily to be dissolved in the water, so which can effectively increase the O₂ content, CO₂ content or other gas content in the water; accordingly, the diffuser can achieve great performance.

(2) In one embodiment of the present invention, the diffuser has the micro-hole thin-film, which can increase the performance of the diffuser. Thus, the high pressure gas cylinder or the gas pump can supply less gas, which can significantly reduce the cost.

(3) In one embodiment of the present invention, the diffuser adopts the micro-hole thin-film with extremely small holes, which are not easily blocked by algae, sand or excrement; in addition, the micro-hole thin-film has higher pressure resistance; hence, the diffuser can be more durable and have longer service life.

(4) In one embodiment of the present invention, the diffuser can generate extremely small and uniform bubbles, so it is very easy to control the gas concentration in the water to prevent the gas concentration from being too high or too low; accordingly, the diffuser can achieve stable performance.

(5) In one embodiment of the present invention, the micro-hole thin-film is elastic; therefore, both of the high pressure gas cylinder and the gas pump can adopt the micro-hole thin-film, which is more flexible in use.

(6) In one embodiment of the present invention, the diffuser adopts the micro-hole thin-film, and the volume of the micro-hole thin-film is much smaller than that of the conventional porous ceramic; thus, the micro-hole thin-film will not influence the landscaping of the aquarium; besides, the micro-hole thin-film can still generate bubbles even if being buried into the sand, which is more convenient in use.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1A˜FIG. 1B are the schematic views of a conventional diffuser.

FIG. 2 is the first schematic view of the first embodiment of the diffuser in accordance with the present invention.

FIG. 3 is the second schematic view of the first embodiment of the diffuser in accordance with the present invention.

FIG. 4 is the third schematic view of the first embodiment of the diffuser in accordance with the present invention.

FIG. 5 is the fourth schematic view of the first embodiment of the diffuser in accordance with the present invention.

FIG. 6 is the schematic view of the second embodiment of the diffuser in accordance with the present invention.

FIG. 7 is the flow chart of the method for generating micro bubbles in accordance with the present invention.

### DETAILED DESCRIPTION OF THE PREFERRED EMBODIMENTS

The technical content of the present invention will become apparent by the detailed description of the following embodiments and the illustration of related drawings as follows.

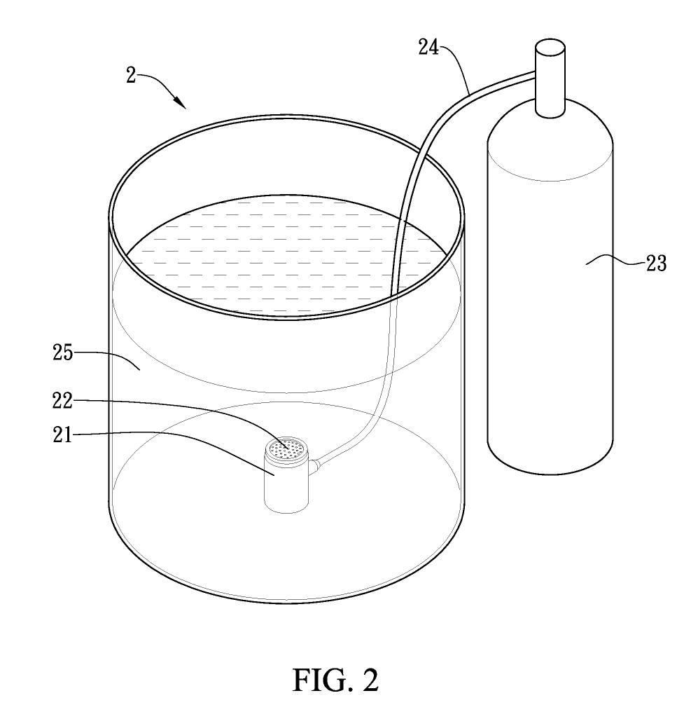

Please refer to FIG. 2, which is the first schematic view of the first embodiment of the diffuser in accordance with the present invention. The diffuser 2 may include a gas tank 21, a micro-hole thin-film 22, a gas supply 23 and a gas tube 24.

The gas tank 21 may be coupled to the gas supply 23 via the gas tube 24, such that the gas supply 23 can transmit gas to the gas tank 21 via the gas tube 24; the gas supply 23 may be a gas pump, high pressure gas cylinder and the like. The micro-hole thin-film 22 may be disposed at the gas outlet of the gas tank 21.

As shown in FIG. 2, the gas supply 23 may transmit pressurized gas to the gas tank 21 through gas tube 24, such that the pressurized gas will jet from the micro-hole thin-film 22 disposed at the gas outlet of the gas tank 21 to generate a great number of micro bubbles in the water tank 2. The micro-hole thin-film 22 can be manufactured by various methods; for example, the micro-hole thin-film 22 can be manufactured by the laser processing, and the diameter of its micro holes may be lower than 30 μm; in a preferred embodiment, the diameter of its micro holes may be 3-20 μm. Therefore, the diffuser 2 with the micro-hole thin-film 22 may generate a great amount of extremely small bubbles which the conventional diffuser cannot generate. The primary object of the present invention is to provide a diffuser with special designed micro-hole thin-film in order to generate micro bubbles; the aforementioned processing method and diameters are just for examples instead of limitations, which will not limit the present invention. The micro-hole thin-film 22 may be made of various materials; in a preferred embodiment, the micro-hole thin-film 22 may be made of metal or plastics.

It is worthy to note that the farmers of the aquaculture usually need to forcibly dissolve various gases into the water; these gases may include air, O2 and CO2, etc., and all of these gases are sparingly soluble in the water. The conventional diffuser usually adopts the porous ceramic, air wood, air stone to forcibly dissolve the above gases into the water in order to generate bubbles in the water; however, these components cannot generate the bubbles easily soluble in the water. For instance, the porous ceramic can only generate big bubbles because the limitations of its material; the diameter of the bubbles generated by the porous ceramic is about 20˜500 μm, so these bubbles are large and non-uniform. As the large bubbles have high buoyancy in the water, they will ascend to the surface of the water in a high speed; thus, the gas in the bubbles will diffuse to the air in a short time before being dissolved in the water. Therefore, the conventional diffuser cannot effectively increase the O₂ content, CO₂ content or other gas content in the water; thus, the conventional diffuser cannot achieve high performance.

On the contrary, in one embodiment of the present invention, the diffuser can generate a large amount of uniform bubbles in the water via the micro-hole thin-film with the diameter less than 30 μm. As the small bubbles have low buoyancy in the water, they will slowly ascend to the surface of the water; in this way, the gas in the bubbles will be easily dissolved in the water, so the diffuser does not need to inject too much gas into the water. Thus, compared with the conventional diffuser, the diffuser according to the present invention can significantly save the usage amount of the high pressure gas cylinder, which can effectively the service life of the high pressure gas cylinder by 3 times and reduce the cost.

Further, as described above, each path inside the porous ceramic is formed by a number of holes randomly connected to each other and is irregular-shaped, so the bubbles generated by which will be non-uniform; moreover, as different porous ceramic may have different quality, it is very hard to control the diffusing efficiency of the porous ceramic and the gas concentration in the water. Furthermore, as the gas is hard to be dissolved in the water, the high pressure gas cylinder should inject more gas into the water to maintain the gas concentration. In consequence, the fishes in the water tank may be accidently killed due to too much CO₂ injected into the water tank. On the contrary, in one embodiment of the present invention, the micro-hole thin-film of the diffuser is manufactured by the special processing method, which can precisely control the diameter of the micro holes, so the micro-hole thin-film is able to generate uniform bubbles; in addition, different micro-hole thin-films have the same quality, so it is very easy to control the diffusing efficiency. Further, the gas in the bubbles generated by the micro-hole thin-film can be easily dissolved in the water, so the high pressure gas cylinder only needs to inject a small amount of gas into the water to maintain the gas concentration in the water. Thus, the diffuser according to the present invention can achieve high precision and high safety.

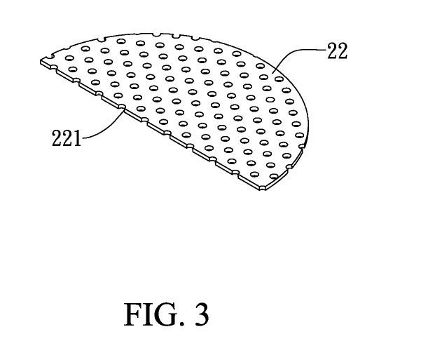

Please refer to FIG. 3, which is the second schematic view of the first embodiment of the diffuser in accordance with the present invention. As described above, the micro-hole thin-film 22 can be manufactured by various methods, such as the laser processing, to generate the micro holes 221 with extremely small diameter. In one embodiment, the diameter of the micro holes 221 may be less than 30 μm, or even be about ±5 μm; as a result, the micro holes can generate extremely small bubbles. Besides, each of the micro holes 221 may be cone-shaped and have a narrow top and a wide bottom, wherein the end of each of micro holes, close to the gas tank, may have larger diameter than the other end of each of micro holes. The above structure can avoid that the bubbles accumulate, so the bubbles can be always small. Besides, the micro-hole thin-film 22 has high pressure resistance, so it is very durable, is not easily blocked by algae, sand or excrement; thus, the micro-hole thin-film can have long service life. Note that the micro-hole thin-film 22 according to the present invention is an extremely thin film; however, in order to clearly show the technical features of the present invention, it is necessary to magnify it in the drawings.

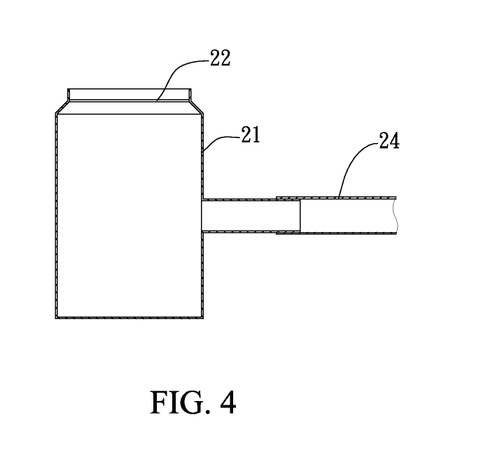

Please refer to FIG. 4, which is the third schematic view of the first embodiment of the diffuser in accordance with the present invention. As shown in FIG. 4, in the embodiment, the micro-hole thin-film 22 may be fixed at the gas outlet of the gas tank 21 (the gas valve adapter), so the gas transmitted into the gas tank 21 by the high pressure gas cylinder can be injected into the water to generate a lot of micro bubbles. The micro-hole thin-film 22 may be made of an elastic material, such as metal or plastics; as a result, the micro-hole thin-film 22 can have high pressure resistance and will not be easily damaged even if connected to a high pressure gas cylinder; obviously, the micro-hole thin-film 22 can have longer service life. Besides, the micro-hole thin-film 22 can also be applied to a gas pump, so it is very flexible in use. On the contrary, as the porous ceramic lacks for elasticity, so it tends to break. Besides, its pressure resistance is only about 30 PSI, but the pressure of the high pressure gas cylinder is up to 2000 PSI; as a result, the porous ceramic will easily break by accident when applied to the high pressure gas cylinder. Furthermore, as described above, the porous ceramic lacks for elasticity (so it can only be applied to the high pressure gas cylinder but cannot be applied to the air pump), so when it is applied to different pressure sources, it needs an additional pressure stabilizing device or an additional pressure reduction device, or its ceramic composition should be changed according to the pressure source. Therefore, compared with the porous ceramic, the micro-hole thin-film 22 according to the present invention is more convenient to use.

It is worthy to note that the conventional diffuser usually uses the porous ceramic, air wood or air stone to generate bubbles in the water, but the holes of these components are large and tend to be blocked by algae, sand or excrement; further, it is very difficult to clean these components after being blocked, which will significantly decrease their service life. Thus, these components may need to be replaced after several days or one week, also, these components tend to break due to high pressure, which will significantly increase the cost of the farmers of the aquaculture. On the contrary, in one embodiment of the present invention, the diffuser adopts the micro-hole thin-film with extremely small holes and special hole structure design, which can effectively prevent the micro-hole thin-film from being blocked by algae, sand or excrement, or breaking due to high pressure; accordingly, the micro-hole thin-film can achieve longer service life and lower cost. Thus, the present invention definitely has an inventive step.

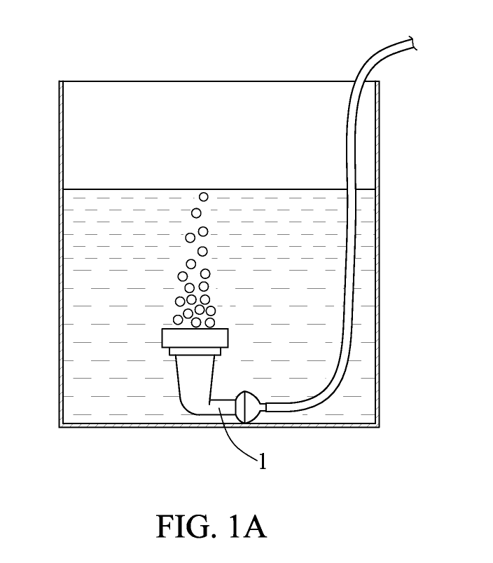

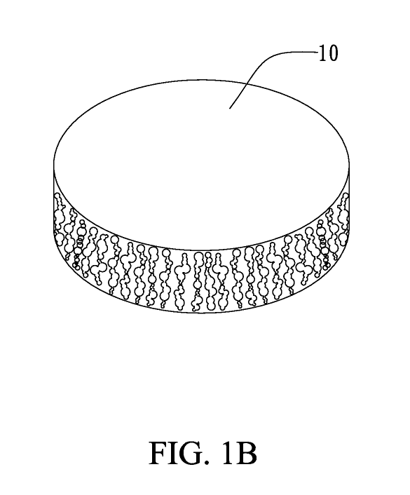

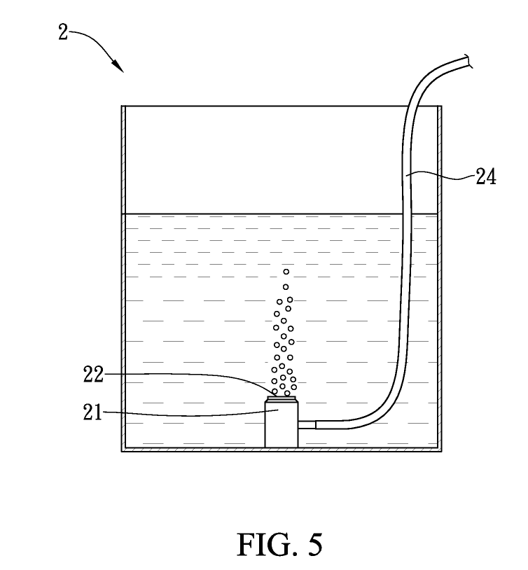

Please refer to FIG. 5, which is the fourth schematic view of the first embodiment of the diffuser in accordance with the present invention. As shown in FIG. 5, the diffuser 2 according to the present invention can generate a large amount of micro bubbles. Since the micro bubbles are extremely small, they have low buoyancy in the water, they will slowly ascend to the surface of the water; moreover, the total contact area of the micro bubbles is larger than that of the large bubbles, so they are apt to be dissolved in the water; therefore, the gas in the micro bubbles can completely be dissolved in the water before the micro bubbles ascend to the surface of the water. On the contrary, as shown in FIG. 1A, the conventional diffuser 1 will generate large bubbles with higher buoyancy in the water, so they will ascend to the surface of the water in a short time; further, the total contact area of the large bubbles is lower than that of the micro bubbles; therefore, the gas dissolution rate of the convention diffuser 1 is much lower than that of the diffuser 2 according to the present invention.

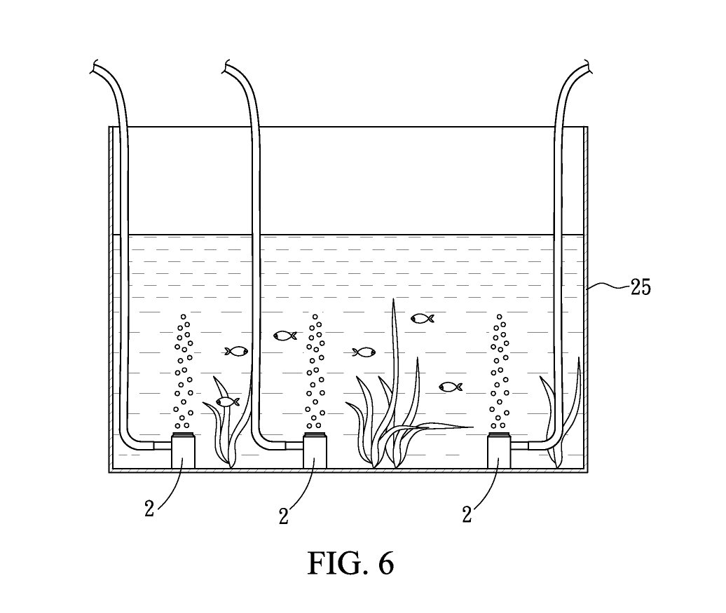

Please refer to FIG. 6, which is the schematic view of the second embodiment of the diffuser in accordance with the present invention. The application of the diffuser 2 according to the present invention is very comprehensive. For instance, the diffuser 2 may be applied to an aquarium to farm water weeds, algae (increase the CO₂ content in the water), or fishes and shrimps (increase the O₂ content in the water); the diffuser 2 may be also applied to the aquaculture to farm various fishes, shrimps and shellfishes (increase the O2 content in the water); the diffuser 2 may be also applied to the hydroponics to farm vegetables or algae; the diffuser 2 may be also applied to the ozone disinfection. As shown in IFG. 6, the diffuser 2 according to the present invention is applied to an aquarium to farm fishes. In the embodiment, there are several diffusers 2 in the water tank 25; however, as the diffuser 2 according to the present invention can achieve high performance, so the quantity of the diffusers 2 necessary for maintaining the gas concentration can be less than that of the conventional diffuser.

It is worthy to note that the conventional porous ceramic tends to be blocked by algae or pollutants in the water; therefore, its working area should be increased to prevent it from being blocked. In general, the working area of the porous ceramic should be about Φ30˜Φ50 mm, and its volume is about Φ45˜Φ60* h:50˜150 mm; however, large volume will influence the landscaping of the aquarium and ruin the appearance of the aquarium. On the contrary, the diffuser according to the present invention adopts the micro-hole thin-film design, which will not be easily blocked, so it does not need large working area. In a preferred, the working area of the diffuser according to the present invention may be Φ6 mm and its volume may be Φ30 mm*L30 mm, which can be modified according to actual requirements and its volume is much smaller than that of the conventional porous ceramic. As a result, when applied to an aquarium, the diffuser according to the present invention can still generate micro bubbles even if being completely hidden in the water weeds or buried into the sand, so the diffuser according to the present invention will not influence the landscaping and the appearance of the aquarium. Therefore, the diffuser according to the present invention exactly has high usability.

Although the above description about the diffuser in accordance with the present invention has illustrated the concept of the method for generating micro bubbles in accordance with the present invention, the following still provides the flow chart to specify the method for generating micro bubbles in accordance with the present invention.

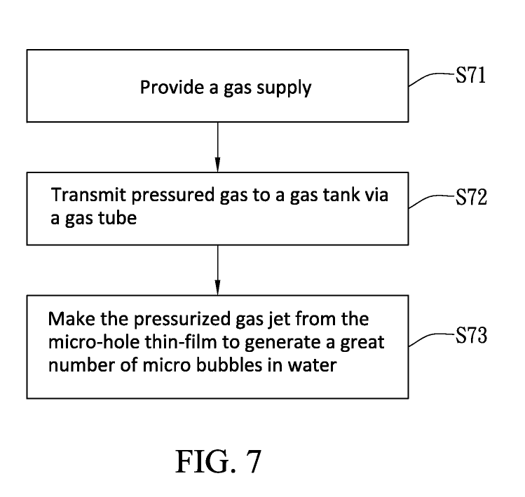

Please refer to FIG. 7, which is the flow chart of the method for generating micro bubbles in accordance with the present invention. The method for generating micro bubbles in accordance with the present invention may include the following steps:

In the step S71: provide a gas supply.

In the step S72: transmit pressured gas to a gas tank via a gas tube.

In the step S73: make the pressurized gas jet from the micro-hole thin-film to generate a great number of micro bubbles in water.

The detailed description and the exemplary embodiments of the method for generating micro bubbles in accordance with the present invention have been described in the description of the diffuser in accordance with the present invention; therefore, they will not be repeated herein again.

To sum up, in one embodiment of the present invention, the diffuser has the micro-hole thin-film, so the diffuser is able to generate a great number of micro bubbles. The micro bubbles are very easily to be dissolved in the water, so which can effectively increase the O₂ content, CO₂ content or other gas content in the water; accordingly, the diffuser can achieve better performance than the conventional diffuser. In one embodiment of the present invention, the diffuser has the micro-hole thin-film, which can increase the performance of the diffuser; thus, the high pressure gas cylinder or the gas pump can supply less gas, which can significantly reduce the cost. In one embodiment of the present invention, the diffuser adopts the micro-hole thin-film with extremely small holes, which are not easily blocked by algae, sand or excrement, and has longer service life. In addition, in one embodiment of the present invention, the diffuser can generate extremely small and uniform bubbles, so it is very easy to control the gas concentration in the water to prevent the gas concentration from being too high or too low; accordingly, the diffuser can be more stable and safe. Further, in one embodiment of the present invention, the micro bubbles generated by the diffuser according to the present invention are much smaller than the conventional diffuser, so the diffuser according to the present invention can achieve high performance and low gas consumption, which can effectively decrease the cost; and both of the high pressure gas cylinder and the gas pump can adopt the micro-hole thin-film, which is more flexible in use. Moreover, in one embodiment of the present invention, the diffuser adopts the micro-hole thin-film, and the volume of the micro-hole thin-film is much smaller than that of the conventional porous ceramic; thus, the micro-hole thin-film will not influence the landscaping of the aquarium; besides, the micro-hole thin-film can still generate bubbles even if being buried into the sand, which is more convenient in use.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A diffuser, comprising:
a gas supply;
a gas tank, being coupled to the gas supply via a gas tube; and
a micro-hole thin-film, comprising a plurality of micro holes and being disposed at an gas outlet of the gas tank;
wherein the gas supply transmits a pressurized gas to the gas tank via the gas tube, and the pressurized gas will jet from the micro-hole thin-film to generate a great number of micro bubbles in water.

2. The diffuser of claim 1, wherein a diameter of each of the micro holes is lower than 30 μm.

3. The diffuser of claim 1, wherein each of the micro holes is cone-shaped and has a narrow top and a wide bottom.

4. The diffuser of claim 3, wherein an end of each of micro holes, close to the gas tank, has larger diameter than the other end of each of micro holes.

5. The diffuser of claim 1, wherein the micro-hole thin-film is a plastic film.

6. The diffuser of claim 1, wherein the micro-hole thin-film is a metal film.

7. A method for generating micro bubbles by a diffuser, comprising the following steps:
providing a gas supply;
transmitting a pressurized gas to a gas tank via a gas tube; and
jetting out the pressurized gas from a plurality of micro holes of a micro-hole thin-film of a gas outlet of the gas tank to generate a large number of micro bubbles.

8. The method of claim 7, wherein a diameter of each of the micro holes is lower than 30 μm.

9. The method of claim 7, wherein each of the micro holes is cone-shaped and has a narrow top and a wide bottom.

10. The method of claim 9, wherein an end of each of micro holes, close to the gas tank, has larger diameter than the other end of each of micro holes.

11. The method of claim 7, wherein the micro-hole thin-film is a plastic film.

12. The method of claim 7, wherein the micro-hole thin-film is a metal film.

13. A gas valve adapter of a diffuser, comprising:
a gas tank, being coupled to a gas supply via a gas tube; and
a micro-hole thin-film, comprising a plurality of micro holes, wherein the micro-hole thin-film is disposed at a gas outlet of the gas tank;
wherein the gas supply transmits a pressurized gas to the gas tank via the gas tube, and the pressurized gas will jet from the micro-hole thin-film to generate a great number of micro bubbles in water.

14. The gas valve adapter of claim 13, wherein a diameter of each of the micro holes is lower than 30 μm.

15. The gas valve adapter of claim 13, wherein each of the micro holes is cone-shaped and has a narrow top and a wide bottom.

16. The gas valve adapter of claim 15, wherein an end of each of micro holes, close to the gas tank, has larger diameter than the other end of each of micro holes.

17. The gas valve adapter of claim 13, wherein the micro-hole thin-film is a plastic film.

18. The gas valve adapter of claim 13, wherein the micro-hole thin-film is a metal film.
